(19) United States
(12) Patent Application Publication
(10) Pub. No.: US 2009/0271489 A1
(43) Pub. Date: Oct. 29, 2009

(54) ELECTRONIC MAIL SYSTEM AND METHOD

(75) Inventors: John Alessi, Garnet Valley, PA (US); William Volz, Havertown, PA (US)

Correspondence Address: WILLIAM H. EILBERG, 316 CALIFORNIA AVE. #785, RENO, NV, 89509, US

(73) Assignee: SOCKETLABS, INC., Garnet Valley, PA (US)

(21) Appl. No.: 12/423,433

(22) Filed: Apr. 14, 2009

Related U.S. Application Data
(60) Provisional application No. 61/047,716, filed on Apr. 24, 2008.

(51) Int. Cl. G06F 15/16; G06F 15/173; G06F 17/30

(52) U.S. Cl. 709/206; 709/224; 707/100; 707/E17.044

(57) ABSTRACT

An electronic mail server processes large numbers of electronic messages. The server includes software which detects various status conditions relating to each message. One or more user-defined software modules are attached to the server software, such that upon detection of a given condition, the associated module is executed. Thus, the modules are executed in real time, i.e. while the main server software is operating. In one example, the user-defined modules can be used to update a database of addresses in real time, when messages to certain addresses in the database are returned as undeliverable.

### CROSS-REFERENCE TO PRIOR APPLICATION

Priority is claimed from U.S. Provisional Patent Application Ser. No. 61/047,716, filed Apr. 24, 2008, entitled “Electronic Mail System and Method”, the entire disclosure of which is incorporated by reference herein.

### BACKGROUND OF THE INVENTION

This invention relates to the field of electronic mail processing, and provides an electronic mail server program which enables users to monitor the status of messages in real time.

Electronic mail (“email”) has become an important aspect of modern life. Millions of messages are sent every day, by individuals and businesses. The volume of email is a substantial portion of the daily traffic on the Internet. Email server programs have therefore been developed to process such messages. Such programs transmit email messages, and handle subsequent events related to the sending of such messages, such as the failure of a message to reach its destination.

When the number of email messages being handled becomes very large, as is true for businesses which send and receive thousands or millions of messages each day, it is useful to be able to track the progress of messages processed by the system. However, in email servers of the prior art, information on the progress of messages has been provided only in the form of “log” files, which may comprise summaries of the disposition of each message. That is, the prior art email servers perform their functions without substantial interaction with the user, and provide information about the disposition of messages only after such functions have been completed.

The present invention provides an improved email server which enables the user to obtain, and use, real-time information about the status of messages. The invention allows the user to produce one or more software modules which interact with the email server program in real time, to take desired actions upon the occurrence of specified events.

### SUMMARY OF THE INVENTION

In its most basic form, the present invention is a computer program (software) for processing electronic mail (email). The software of the present invention includes means for accepting email messages, generated or transmitted by a user-defined program, and sending those messages over the Internet, while also being capable of receiving communications pertaining to the sent messages.

The software also includes one or more functions which are called when certain predetermined events occur. For example, one such event may be defined as the condition wherein a message is returned as undeliverable. A specific function, or subroutine, is called when the latter event occurs. Other functions pertain to other defined events. Each such function includes a software-based “hook”, which allows a user-defined software module, or “plugin”, to be executed. Thus, when a particular event occurs, and the corresponding function is called, the software of the present invention seamlessly, and in real time, executes the user-defined software module that has been attached to the above-mentioned function.

Because one or more user-defined software modules are executed immediately upon the occurrence of certain events, the software of the present invention can respond to such events substantially in real time. Thus, for example, the software of the present invention can update a user's database by removing invalid email addresses, and this updating process can occur almost immediately after a message has bounced back.

The present invention therefore contrasts with prior art systems, wherein the occurrence of particular events could only be determined by analysis of a log file generated after the processing is completed, and wherein actions based on such events could only be taken on a delayed basis.

The present invention therefore has the primary object of providing software for operation of an electronic mail server.

The invention has the further object of providing a programmed computer, having software for operating an electronic mail server.

The invention has the further object of providing an electronic mail server having the ability to execute user-defined software modules.

The invention has the further object of providing an electronic mail server which executes user-defined software modules in response to the occurrence of specified conditions or events, the user-defined software modules being executed essentially in real time.

The invention has the further object of enabling the user of an electronic mail server to obtain immediate information about the disposition of messages, and to take action without waiting for other email operations to complete.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 provides a block diagram illustrating a typical use of the software of the present invention.

FIG. 2 provides a table of functions which are supported by the email server of the present invention.

FIG. 3 provides a flow chart illustrating another example of the use of the software of the present invention.

FIG. 4 provides a schematic diagram representing the essential features of the software of the present invention.

### DETAILED DESCRIPTION OF THE INVENTION

The present invention comprises a computer program for processing electronic mail (“email”). The computer program of the present invention may be implemented on various hardware platforms, i.e. computers of various types, and is not limited to any particular platform. The programmed computer which processes email is called a server. In this specification, the term “server program” will be used to refer to the program alone, i.e. to the software which is intended to be installed on the hardware.

The email server program of the present invention enables a user to create “plugins”, i.e. modules of code written by the user, which are executed by the server program at appropriate times. Each plugin can contain one or more entry points. Each plugin is normally intended to take action in response to a different server event.

In a simple example, suppose that the user is a business which desires to send an email message to thousands of customers. In any large database, it is likely that some of the addresses contained therein have become invalid. The user therefore wishes to strike from the database any addresses for which the message cannot be delivered. To accomplish this objective, the user prepares a software module which updates the database of addresses by deleting a particular address. The latter software module is attached, by software, to the email server program. When a message bounces back because its address is invalid, the server program executes a function which, in turn, executes the user-defined software module. The software module is executed substantially in real time, i.e. while the server program is in operation. In the above example, execution of the software module causes the invalid address to be deleted immediately from the database.

In general, the present invention gives the user immediate feedback concerning the status of messages, and the ability to execute a customized program in response to a bounce-back event, or other event or condition.

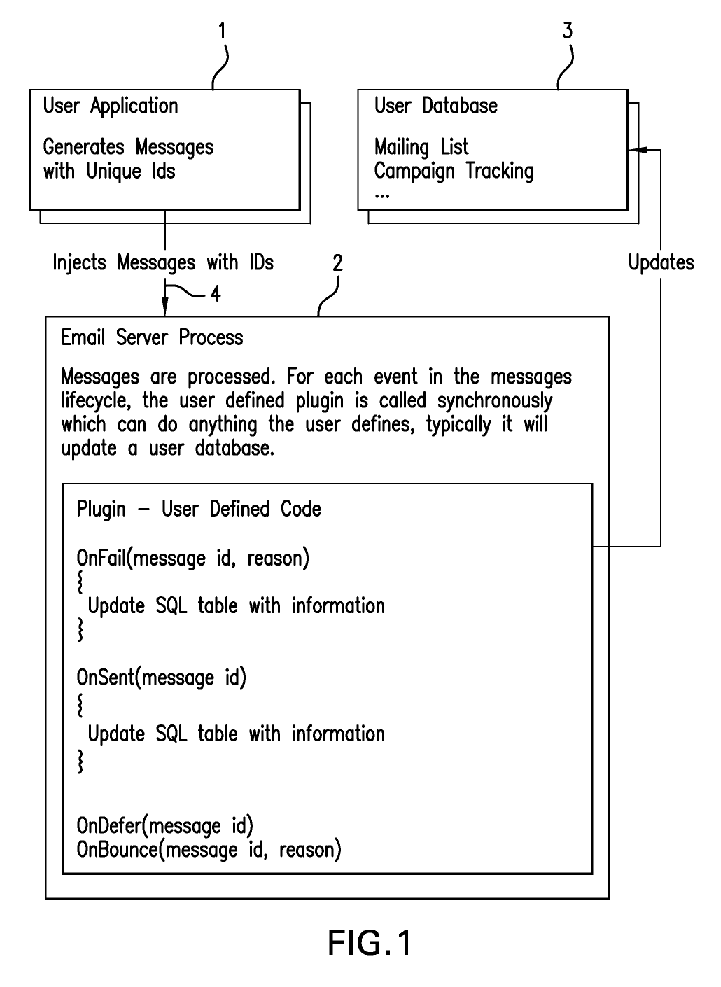

FIG. 1 provides a block diagram illustrating the use of the present invention. Block 1 represents a program, provided by the user, for generating email messages. Thus, the program in block 1 does not form part of the software of the present invention. Each email message produced in block 1 preferably includes a unique identifier. The messages are transferred to the email server as indicated by arrow 4.

The messages injected into the server preferably include more than one identifier, such as one or more user-defined message identifiers and/or one or more mailing identifiers. These identifiers are preferably associated with the message throughout its “life cycle”, i.e. throughout the time that the message is processed by the system. These identifiers can be passed to, or from, the user-defined plugins enabling the user to track the individual disposition of each message sent.

Block 2 represents the email server software of the present invention. The messages are processed, meaning that the software sends each message through the Internet, and monitors the status of each message that has been sent. Monitoring the status of a message means monitoring events associated with that message, as reported to the server software. For example, if the address of the recipient of the message is not valid, the server program receives a “bounce back” notification. If the message failed to reach the destination entirely, the server program receives a “fail” notification. Various other notifications may be received by the server program, as will be explained in more detail later.

As part of the processing of messages, the server software of the present invention invokes various functions which conditionally call the software modules or plugins created by the user. FIG. 1 shows, as examples, four such functions, namely “OnFail”, “OnSent”, “OnDefer”, and “OnBounce”. These functions are called, respectively, when a message has failed permanently, when a message has been successfully sent, when a message delivery attempt has failed but the message has been queued for a delivery attempt later, and when a bounce message is received.

Each call to a function may involve the passing of one or more arguments to or from the function. In the example given in FIG. 1, the OnFail function has the arguments “message ID” and “reason”. That is, the function returns a message identifier and a reason for the failure. The OnSent function, in the example shown, has only the argument “message ID”.

In block 2 of FIG. 1, following the OnFail and OnSent functions, there are shown, in brackets, a user-defined plugin, labeled “Update SQL table with information”. The latter represents software, written by the user, which updates the user's database, such as by removing an invalid email address from that database. The user database is symbolized by block 3. It, too, is not part of the server software of the present invention.

In summary, the email server program of the present invention calls (executes) various functions, depending on events which are reported to the program at the time of, or after, the sending of a message. When a function is called, the user-defined plugin, which is specifically associated with that function, is executed. If there is no user-defined plugin associated with a particular function, the program simply loops back, ignoring that function, and proceeds to its next operation.

In general, there may be more than one user-defined plugin associated with a particular function, in which case all such plugins are executed when the function is called. That is, the occurrence of a particular event or condition could cause the execution of multiple user-defined plugins.

From the above example, it is apparent that the server program of the present invention enables the user to update a database, or perform other operations, in real time. That is, the database is updated virtually immediately, each time a bounce back or other notification is received. There is no need to analyze a log file, generated after the fact. The updating of the database need not wait until the log file has been generated.

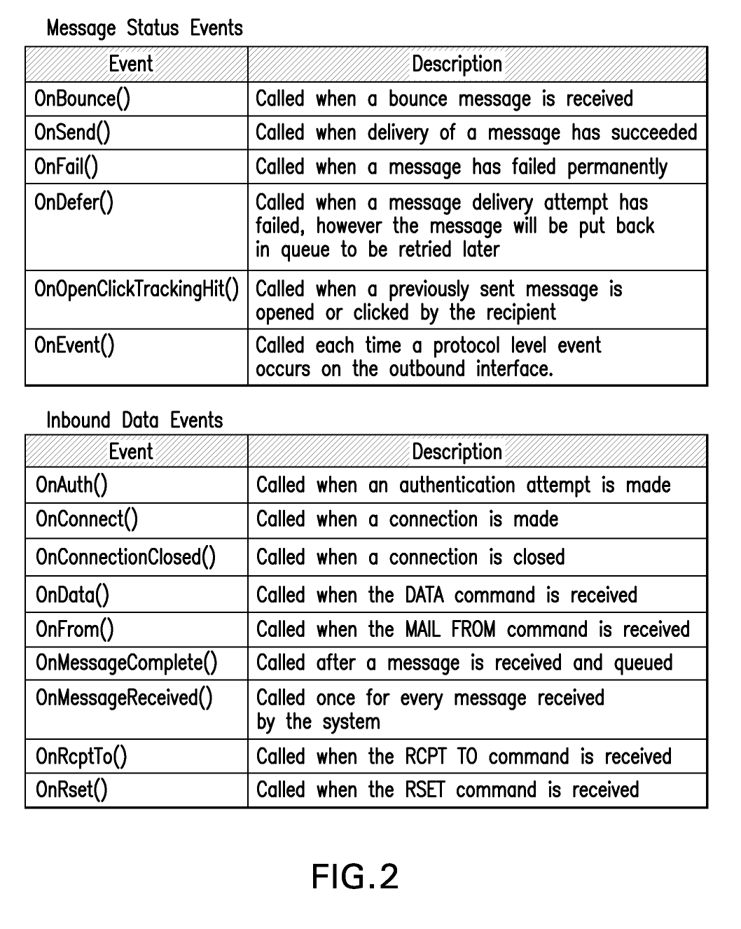

FIG. 2 provides a table showing various functions which may be included in the server software of the present invention. Each function name is followed by parentheses to indicate that the function may have one or more arguments which may be passed to, or from, the function. Each function in the table is accompanied by a description of the event or condition which causes the function to be called.

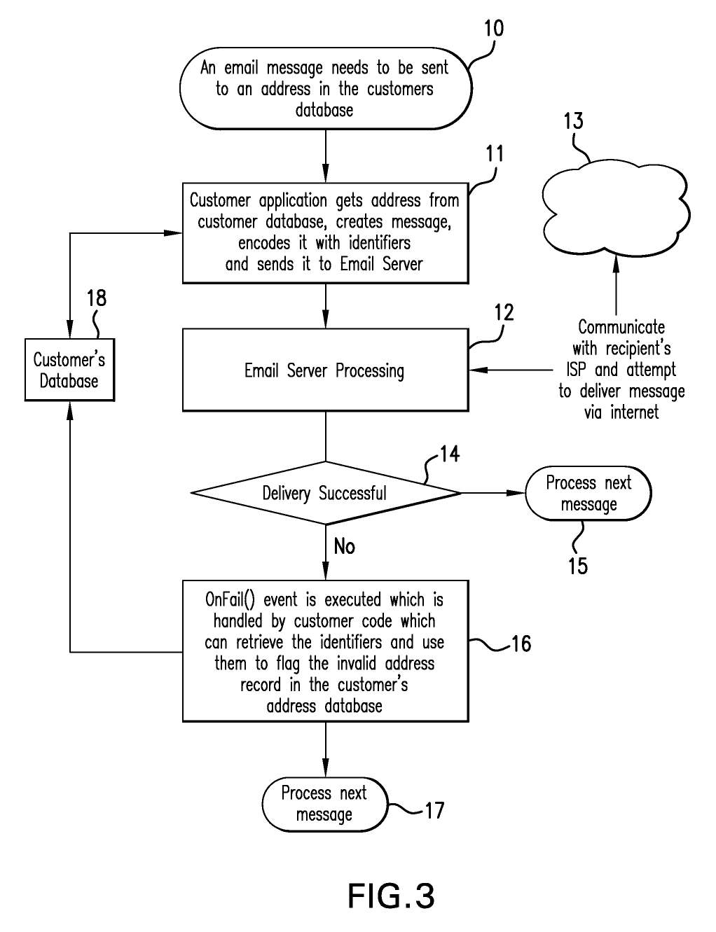

FIG. 3 provides a flow chart illustrating a more specific example of the use of the software of the present invention. In block 10, an email message is to be sent to an address in a user's database. In block 11, the user's software obtains the next address from the database, creates the message, encodes the message with one or more identifiers, and sends it to the email server, represented in block 12. The email server transmits the message, via the Internet, to the recipient's Internet Service Provider (ISP), or email host, represented generally by reference numeral 13. If the message is successfully delivered, as determined by test 14, the system proceeds, in block 15, to process the next message. If the message is not delivered, the OnFail function is executed, in block 16, which includes calling one or more user-defined plugins associated with the OnFail function. In this example, the user has written a program which uses the identifiers to flag the invalid address record in the address database, represented by block 18. The system then proceeds, in block 17, to process the next message.

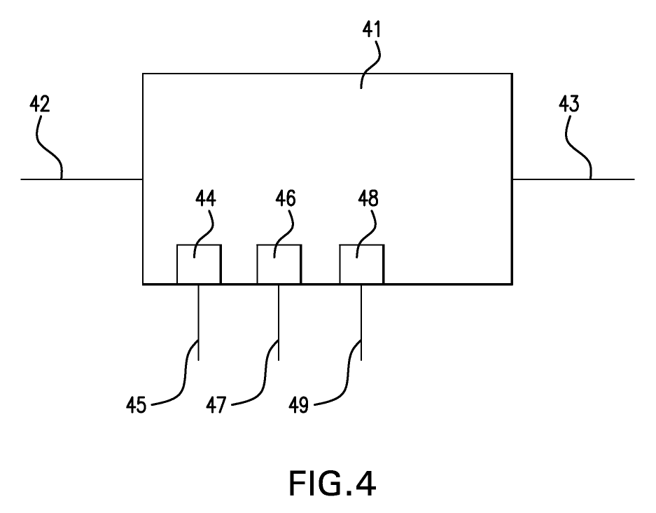

FIG. 4 provides a schematic diagram which represents the software of the present invention. Unlike the illustrations of FIGS. 1 and 3, the diagram of FIG. 4 shows only the present invention, and does not include components which are external to the invention.

Block 41 represents, in general, the email server software of the present invention. This software includes means, identified by reference numeral 42, for accepting messages to be sent. Such messages are generated by a user, with the help of software operated by the user, external to the email server software. The software of the present invention also includes communication means 43, through which the software sends messages over the Internet, and through which the software also receives messages from the Internet.

Shown within block 41 are functions 44, 46, and 48. Only three such functions are illustrated, for purposes of simplicity, but it is understood that there could be more functions, such as those summarized in FIG. 2, and additional functions. The functions are provided with links or “hooks” 45, 47, and 49, respectively. These links or hooks are not physical objects, but are portions of software which allow the functions to link to, and thus execute, software modules or plugins provided by the user.

In another embodiment, the present invention can comprise the combination of a computer and the software described above. That is, in one embodiment, the invention comprises a programmed computer, the computer being programmed to execute the email server software described above. In this case, the diagram of FIG. 4 can be re-interpreted to symbolize the programmed computer having the ability to receive message data (through line 42) from a user, and having the ability to send and receive communications (through line 43) via the Internet. The programmed computer also has access, through its included software, to the functions 44, 46, and 48, each of which includes software-based hooks 45, 47, and 49 which can be “attached”, by software, to user-defined code modules.

The functions listed in FIG. 2 can be designed to have more or fewer arguments than what is shown in the example of FIG. 1. In general, the server software could be programmed to assign more than one identifier, such as an account identifier and a message identifier, to a message. The software could also be programmed to recognize additional identifiers embedded in the message by the user, such as a user-defined message identifier and/or a mailing or campaign identifier. Such additional identifiers facilitate extraction of useful information from the results of the above-described functions.

The software may also include programming which allows the user-defined software module(s) to change the default processing of the email server, or to modify data pertaining to an event. For example, the OnMessageReceived function could enable user-defined code to signal that the message should be rejected, or even to change the content of the message.

The use of additional message identifiers helps to provide information about the disposition of bounced messages. In many cases, when a message bounces back, some information from its header may not be preserved, and the message identifier may be lost. By keeping track of a separate identifier for the message, the system can restore identifying information to a bounced message, and can therefore provide useful information on the disposition of the message.

The invention is not limited to use according to the examples described above. Additional possible uses are as follows.

The user-defined code could be programmed to respond to the OnMessageReceived function by scanning a received email message for viruses, and rejecting or repairing the message if a virus is detected.

The user-defined code could respond to virtually any event, and post the raw event data into a customer database for later analysis.

The user-defined code could respond to the OnSent and OnFail functions and could archive all information relating to these events and corresponding messages, for regulatory compliance.

Also, the specific example described above involved the modification of a database. But a database is not required to use the present invention, and the invention is not limited to altering a database in response to status conditions relating to email messages. For example, in response to a failed email operation, a software module could be programmed to send another electronic message, or to shut down a piece of equipment, or to perform some other task.

All of the above are just a few of the virtually infinite numbers of ways in which the present invention can be used.

The invention can be described more generally as follows. The email server includes a program which can track at least one status condition relating to the messages to be sent. Examples of such status conditions are those listed in FIG. 2, but the invention is not limited to the items in this list. The user generates one or more software modules, each software module being intended to be executed upon the fulfillment of a given status condition tracked by the server. The software modules are attached to the main server program, so that the modules are executed whenever the associated status condition is fulfilled. When such condition is not fulfilled, the module is bypassed, and not executed.

The main server program therefore operates independently of the software module, regardless of whether the module is executed. Thus, the software module(s) can be operated in real time, i.e. at the same time that the main server program is in operation.

In practice, the main server program and the modules are produced by different entities, the module being produced by a user of the server program, and therefore being customized to the needs of the user. In general, the customized software modules may operate to alter data, stored in a database, relating to addresses to which email messages are sent. The invention is not limited to such use, however.

The invention can be modified in various ways. The invention is not limited to use with any particular program for generating email messages. It is not limited by the type or number of functions used. Such modifications, which will be apparent to those skilled in the art, should be considered within the spirit and scope of the following claims.

What is claimed is:

1. A method of managing an electronic mail server, wherein the server comprises a computer program for sending electronic mail messages, the program comprising means for tracking at least one status condition relating to said messages, the method comprising:
a) generating at least one software module which is to be executed upon fulfillment of a status condition which is tracked by the server, and
b) attaching said software module to the server such that the software module is automatically executed when said condition is fulfilled.

2. The method of claim 1, further comprising bypassing said software module, without execution of same, when said condition is not fulfilled.

3. The method of claim 1, wherein the server operates independently of said software module regardless of whether the module is operated.

4. The method of claim 1, wherein the server and the module are produced by distinct entities, the module being produced by a user of the server and being customized by the user.

5. The method of claim 1, wherein messages are sent to addresses stored in a database, and wherein said software module comprises means for altering data in said database in response to detection of said condition.

6. The method of claim 1, further comprising executing the software module while the server is being operated, wherein the software module is executed in real time.

7. The method of claim 1, wherein step (a) is performed a plurality of times, for a plurality of conditions, so as to generate a plurality of software modules, and wherein step (b) comprises attaching all of said modules to the server.

8. An electronic mail server system, comprising:
a) a main server program, the main server program comprising means for sending electronic mail messages, and
b) at least one user-defined software module, the software module being attached to the server program such that the module can be executed while the server program is operating, the module being designed to be executed only upon fulfillment of a status condition relating to an electronic mail message being sent.

9. The system of claim 8, wherein the server program comprises means for bypassing said software module, without execution of same, when said condition is not fulfilled.

10. The system of claim 8, wherein the server program operates independently of said software module regardless of whether the module is operated.

11. The system of claim 8, wherein the server program and the module are produced by distinct entities, the module being produced by a user of the server program and being customized by the user.

12. The system of claim 8, further comprising a database containing addresses to which said messages are sent, and wherein said software module comprises means for altering data in said database in response to detection of said condition.

13. The system of claim 8, wherein the module is configured so as to be executable while the server program is also being operated.

14. The system of claim 8, wherein there are a plurality of software modules, each software module being associated with a different condition, all of said software modules being attached to the server program and being capable of execution while the server program is operating.

15. A system for processing of electronic mail, comprising:
a) a programmed computer, the computer having a memory in which a main server program is loaded, the main server program comprising means for sending electronic mail messages, and
b) the computer memory being programmed with at least one user-defined software module, the software module being attached to the server program such that the module can be executed while the server program is operating, the module being designed to be executed only upon fulfillment of a status condition relating to an electronic mail message being sent.

16. The system of claim 15, wherein the server program comprises means for bypassing said software module, without execution of same, when said condition is not fulfilled.

17. The system of claim 15, wherein the server program operates independently of said software module regardless of whether the module is operated.

18. The system of claim 15, wherein the server program and the module are produced by distinct entities, the module being produced by a user of the server program and being customized by the user.

19. The system of claim 15, wherein the memory includes a database containing addresses to which said messages are sent, and wherein said software module comprises means for altering data in said database in response to detection of said condition.

20. The system of claim 15, wherein the module is configured so as to be executable while the server program is also being operated.

21. The system of claim 15, wherein there are a plurality of software modules, each software module being associated with a different condition, all of said software modules being attached to the server program and being capable of execution while the server program is operating.
